(19) United States
(12) Patent Application Publication
(10) Pub. No.: US 2004/0267553 A1
(43) Pub. Date: Dec. 30, 2004

(54) Evaluating storage options

(76) Inventor: Greg M. Brunton, New South Wales (AU)

Correspondence Address: BAKER BOTTS L.L.P., 2001 ROSS AVENUE, 6TH FLOOR, DALLAS, TX, 75201, US

(21) Appl. No.: 10/607,440

(22) Filed: Jun. 25, 2003

(51) Int. Cl. G06F 17/60

(52) U.S. Cl. 705/1; 705/7

(57) ABSTRACT

Evaluating storage options includes identifying workload descriptors associated with a storage instance, where each workload descriptor corresponds to a data characteristic, and where the storage instance has one or more storage attributes. For each workload descriptor of the plurality of workload descriptors a workload descriptor is selected. A weight and a workload parameter value is associated with the selected workload descriptor, where the weight represents an impact of the workload parameter value on a storage attribute of the storage instance. One or more storage options are evaluated in accordance with the weight and the workload parameter value. A storage option from the one or more storage options is determined for the storage instance according to the evaluation of the one or more storage options.

### TECHNICAL FIELD OF THE INVENTION

This invention relates generally to the field of storage management and system design and more specifically to a method and system for evaluating storage options.

### BACKGROUND OF THE INVENTION

Managing storage generally involves analyzing storage options to identify a storage solution. A known technique for analyzing storage options involves using a host centric view that focuses on the requirements of a system and its components and the environment where the system may be running. For example, a vendor may suggest a storage solution that uses host equipment that the vendor prefers. Another technique for analyzing storage options may use an application centric view that focuses on the applications running in the system. For example, a vendor may recommend a storage solution driven by the applications already running at the system. Focusing on either the environment or the applications of a system, however, may ignore the characteristics of the data being serviced by the system. Ignoring data characteristics may result in inadequate storage options being considered for implementation. Consequently, known techniques for managing storage may be inadequate in certain circumstances.

### SUMMARY OF THE INVENTION

In accordance with the present invention, disadvantages and problems associated with previous techniques for evaluating storage options may be reduced or eliminated.

According to one embodiment, evaluating storage options includes identifying workload descriptors associated with a storage instance, where each workload descriptor corresponds to a data characteristic, and where the storage instance has one or more storage attributes. For each workload descriptor of the plurality of workload descriptors a workload descriptor is selected. A weight and a workload parameter value is associated with the selected workload descriptor, where the weight represents an impact of the workload parameter value on a storage attribute of the storage instance. One or more storage options are evaluated in accordance with the weight and the workload parameter value. A storage option from the one or more storage options is determined for the storage instance according to the evaluation of the one or more storage options.

Certain embodiments of the invention may provide one or more technical advantages. A technical advantage of one embodiment may be that a more suitable storage solution may be selected by considering the impact of data characteristics in the evaluation of storage options. Another technical advantage of an embodiment may be that a more cost effective storage solution may be selected by considering aspects of data characteristics that affect contractual, physical, and technical aspects of implementing the storage solution. Yet another technical advantage of an embodiment may be that storage management may be more vendor independent by focusing on the data services required and not on the applications or the environment of the system.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram of an embodiment of a system for evaluating storage options in accordance with the present invention;

FIG. 2 is a diagram of an embodiment of a storage instance report that may be generated using the system illustrated in FIG. 1;

FIG. 3 is a diagram of an embodiment of a storage option report that may be generated using the system illustrated in FIG. 1; and

FIG. 4 is a flowchart illustrating one embodiment of a method for evaluating storage options in accordance with the present invention.

### DETAILED DESCRIPTION OF THE DRAWINGS

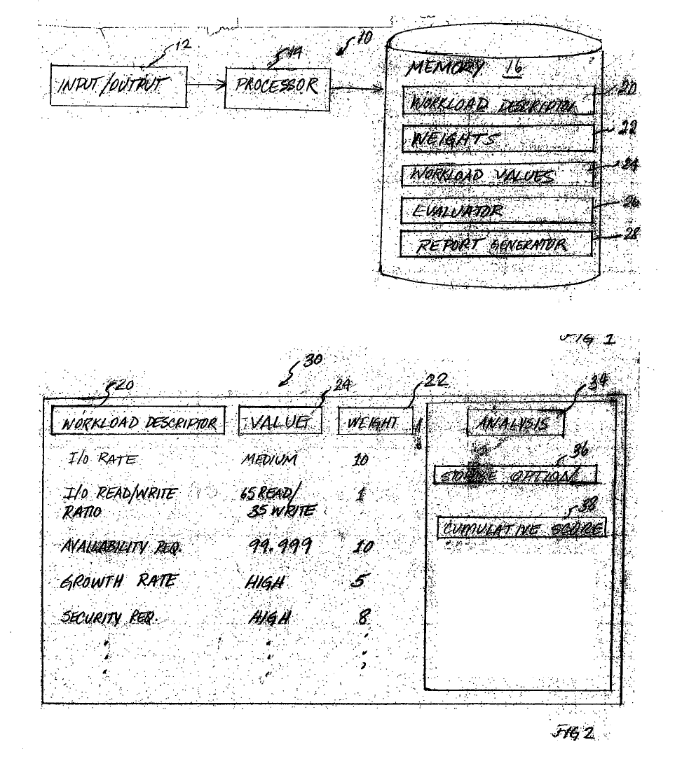

Embodiments of the present invention and its advantages may be best understood by referring to FIGS. 1 through 4 of the drawings, like numerals being used for like and corresponding parts of the various drawings.

FIG. 1 is a block diagram of an embodiment of a system 10 for evaluating storage options for a storage instance in accordance with the present invention. A storage instance may comprise systems, services, or applications requiring data storage such as online transaction processing (OLTP) systems, document storage systems (DSS), email systems, workgroup applications, enterprise resource planning (ERP) systems, customer relationship management (CRM) systems, utility platforms, any other suitable system requiring data storage, or some, none, or all of the preceding. Storage options may comprise storage systems that may be evaluated to select from them a storage solution that may satisfy at least some of the storage needs of a storage instance.

Computer system 10 may comprise a portion of an application for evaluating storage options. Computer system 10 may be adapted to execute any of the well known MS-DOS, PC-DOS, OS2, UNIX, MAC-OS, and Windows operating systems or any other suitable operating system. As used in this document, the term “computer” refers to any suitable device operable to accept input, process the input according to predefined rules, and produce output, for example, a personal computer, work station, network computer, wireless telephone, personal digital assistant, one or more microprocessors within these or other devices, or any other suitable processing device.

Computer system 10 includes an input/output module 12, a processor 14, and a memory 16 coupled as shown in FIG. 1. Input/output module 12 receives input from a user and communicates output to the user. Input/Output module 12 may include devices such as a keyboard, a mouse, a touch screen, a pointing device, a scanner, a printer, disk drives, a display, communication links, or any other suitable device.

Processor 14 executes programs that may be stored at memory 16. Memory 16 may include Random Access Memory (RAM), Read Only Memory (ROM), magnetic drives, disk drives, Compact Disk (CD) Drives, Digital Video Disk (DVD) drives, removable media storage, any other suitable data storage device, or a combination of any of the preceding. Memory 16 may be coupled to processor 14 and input/output module 12 using a bus connection, one or more local area networks (LANs), metropolitan area networks (MANs), wide area networks (WANs), a global computer network such as the Internet, or any other appropriate wire line, wireless, or other links.

Memory 16 includes a workload descriptor 20, weights 22, workload values 24, an evaluator 26, and a report generator 28. According to one embodiment, workload descriptor 20, weights 22, and workload values 20 may be stored in one or more data files, and evaluator 26 and report generator 28 may be stored in one or more executable files. Memory 16 may include other or additional modules without departing from the scope of the invention.

Workload descriptor 20 may include one or more parameters associated with a storage instance for which storage options are being evaluated. According to one embodiment, the parameters represent meta-data drivers or attributes corresponding to the data associated with a particular storage instance. For example, workload descriptor 20 may include parameters representing input/output attributes of the data such as input/output rates, input/output access pattern, input/output block size, and input/output read/write ratios, where these attributes are associated with storage attributes of the storage instance. Other suitable parameters may be used. For example, workload descriptor 20 may include latency tolerance parameters, outage impact parameters, availability requirement parameters, growth rate parameters, access method parameters, multiple host file sharing parameters, security requirement parameters, accepted cost of entry parameters, redeployment flexibility parameters, hardware Business Continuance Volume (BCV) support parameters, snapshot feature parameters, clustering support parameters, usage lifespan parameters, or flexibility parameters, other parameters, or some, none, or all of the preceding.

According to the illustrated embodiment, parameters may be selected based on a technical criteria, a physical criteria, a contractual criteria, or any combination of the preceding. For example, the parameters of workload descriptor 20 may be selected based on whether the parameters may affect technical aspects of the storage options, whether the parameters may affect at least one contractual aspect of selecting the storage options, or whether the parameters may affect physical aspects of the storage options. As an example of a parameter that may affect technical aspects, workload descriptor 20 may include an input/output read/write ratio parameter that specifies a read/write ratio for the data of the storage instance, for example, 65 reads/35 writes. As an example of a parameter that may affect contractual aspects of storage options, workload descriptor 20 may include an availability requirement parameter that specifies a percentage of availability for the storage instance, for example 99.99%. As an example of a parameter that may affect physical aspects of a storage option, workload descriptor 20 may include a growth rate parameter that specifies a rate of growth for the storage instance, for example, a high rate of growth.

Although parameter selection has been described using one of the predetermined categories, a parameter may fall into more than one category. For example, a security requirement parameter may affect both the technical and contractual aspects of a storage option. Any suitable number of parameters may be selected to be included at workload descriptor 20, and any other suitable criteria may be used to select those parameters.

Weights 22 may include a weight associated with a parameter of a workload descriptor 20. A weight may represent the level of impact that the parameter has on the storage options being evaluated. For example, a high weight may be associated with a parameter that has a large impact on which storage option is selected. The weight may be selected to reflect the relative needs of a storage instance. According to one embodiment, if storage options are being evaluated for an OLTP system, a high weight may be associated with access method parameters, multiple host file sharing parameters, hardware BCV support parameters, snapshot feature parameters, and clustering support parameters. Weight 22 association may vary depending on the storage instance and storage options being evaluated. For example, a different set of weights 22 may be associated with parameters for evaluating storage options associated with data for an email system.

According to one embodiment, weights 22 may comprise numerical values in any range such as from one to ten, where one represents a low level of impact and level ten represents a high level of impact. Any other suitable range or representation of weights 22 may be used without departing from the scope of the invention. For example, weights 22 may be selected from a range having higher or lower values.

Workload values 24 may include a set of values associated with each parameter of workload descriptor 20. A workload value 24 may represent a potential value characteristic of the parameter. For example, the usage lifespan parameter may be associated with values “2 to 3 years”, “1 to 2 years”, “6 months to 1 year”, and “1 month to 6 months.” As yet another example, the flexibility parameter may be associated with values “high”, “average”, and “low.”

Parameters of workload descriptor 20 may be associated with any suitable number of values of workload values 24 without departing from the scope of the invention. Other suitable values may be included as workload values 24. For example, workload values 24 may include numerical ranges, yes/no values, or any other suitable value that may correspond to a specific data characteristic associated with workload descriptor 20. As another example, a workload descriptor 20 including an I/O axis pattern parameter may be associated with values such as “full random,” “good mixture,” “sequential right,” “mixed reads,” and “concurrent sequential writes.” As yet another example, a latency tolerance parameter may be associated with values such as “lowest: from five to seven milliseconds,” “low: from seven to ten milliseconds,” “average: from five to twelve milliseconds,” and “high: from ten to thirty milliseconds.” As yet another example, the availability requirement parameter may be associated with values ranging from 99.5 to 99.999.

A workload value may be selected to describe a storage instance. For example, if the data for the storage instance may require to be serviced during the lifespan of one to two years, the value of “1 to 2 years” may be selected and associated with the usage lifespan parameter of workload descriptor 20. According to the illustrated embodiment, one value of workload values 24 is selected for each parameter of workload descriptor 20.

Evaluator 26 evaluates at least one storage option according to a weight 22 and a workload value 24. According to the illustrated embodiment, evaluator 26 computes a cumulative score for each storage option being analyzed based on weight 22 and the selected workload value 24. For example, to evaluate storage options for an OLTP system, evaluator 26 computes a score for each workload descriptor 20 of each storage option using weight 22 and the selected workload value 24. Evaluator 26 accumulates the scores for each storage option and may rank the storage option based on the cumulative scores obtained. According to one embodiment, evaluator 26 multiplies weight 22 with the selected value of workload values 24 to obtain a raw score for each storage option and each workload descriptor 20. Evaluator 26 may sum the raw scores for each storage option to obtain a cumulative score for each storage option. Any other suitable computation may be used by evaluator 26 to evaluate storage options. For example, each storage option may be assigned a percentage of compliance with the parameters of workload descriptor 20, and the percentage may be used to generate a score for each workload descriptor 20. By way of illustration, if a director-based storage area network (SAN) and switch-based SAN are being evaluated, evaluator 26 may determine that a value of “high” for an I/O rate parameter may yield a higher raw score for the director-based SAN option than the switch-based SAN option because the director-based SAN option may have a higher percentage of compliance with a high I/O rate than the switch-based SAN option.

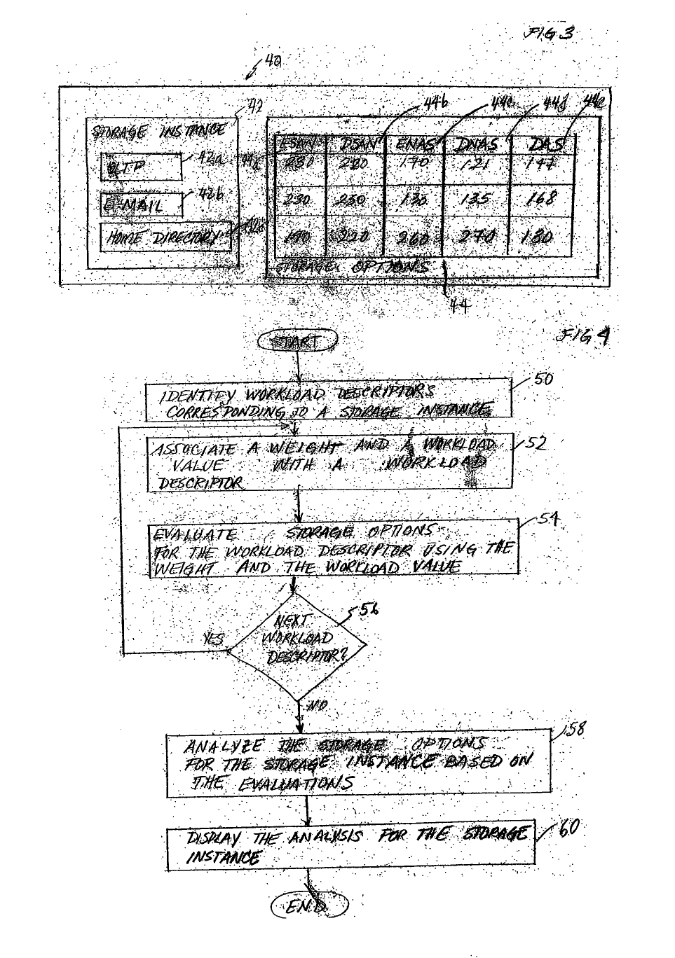

Report generator 28 generates reports describing the evaluation of workload descriptor 20. According to the illustrated embodiment, report generator 28 generates a storage instance report illustrating the associations between workload descriptor 20 workload values 24, and weight 22. The storage instance report is more particularly described with reference to FIG. 2. Report generator 28 may also generate a ranking report indicating the ranking of the cumulative scores for each evaluated storage option. The ranking report is more particularly described with reference to FIG. 3. Any other suitable reports may be generated by report generator 28 without departing from the scope of the invention.

Modifications, additions, or omissions may be made to system 10 without departing from the scope of the invention. For example, memory 16 may include a batch generator module that may be used to automatically select and associate a weight 22 and a workload value 24. As another example, workload descriptor 20 may be modified to include workload profiles that may be used to group workload descriptors 20 that are shared by a specific storage instance. For example, if storage options for a specific storage instance such as an OLTP system are being evaluated, workload descriptors 20 may be grouped to form a workload profile that includes workload descriptors 20 common among OLTP systems.

In summary, system 10 evaluates storage options for a storage instance using workload descriptor 20 that is associated with weights 22 and workload values 24 that describe the data delivery and data storage requirements of the storage instance. Weights 22 and workload values 24 are used by evaluator 26 to determine which storage option may satisfy the requirements. Any storage instance may be analyzed by system 10 such as e-mail systems, work group systems, DSS systems, and OLTP systems. Additionally, any storage option may be evaluated, such as storage area networks that are director-based and switch-based, network attached storage (NAS) appliance systems, NAS gateway systems, direct attached storage (DAS), any other suitable storage option, or none, all, or a combination of the preceding.

A diagram of an embodiment of a storage instance report that may be generated by system 10 of FIG. 1 is described with reference to FIG. 2. A diagram of an embodiment of a storage option report that may be generated by system 10 of FIG. 1 is described with reference to FIG. 3. A flowchart illustrating one embodiment of a method for evaluating storage options in accordance with the present invention is described with reference to FIG. 4. As used in this document, “each” refers to each member of a set or each member of a subset of a set. Additionally, functions may be performed using any suitable logic comprising software, hardware, other logic, or any suitable combination of the preceding.

FIG. 2 is a diagram of an embodiment illustrating a storage instance report 30 that may be generated by system of 10 of FIG. 1. According to the illustrated embodiment, storage instance report 30 includes workload descriptor 20, workload values 24, weights 22, and an analysis portion 34. Report generator 28 may generate storage instance report 30 to illustrate the relationships among workload descriptor 20, workload values 24, and weights 22 for a particular storage instance. In the illustrated embodiment, storage instance report 30 may correspond to an OLTP system where a value of “medium” and a weight of “10” are associated with an I/O rate parameter of workload descriptor 20. The sections illustrating workload descriptor 20, workload values 24, and weights 22 may include any suitable number of parameters, values, and weights that may be associated with the storage instance. Additionally the parameters of workload descriptor 20, the values of workload values 24, and the weights of weights 22 may be illustrated in any suitable manner without departing from the scope of the invention.

Analysis portion 34 may include storage option 36 and cumulative score 38. According to the illustrated embodiment, analysis portion 34 includes the storage option 36 that evaluator 26 determined as having the highest cumulative score. The cumulative score section 38 may illustrate the cumulative score associated with the storage option 36.

Modifications, additions, or omissions may be made to the storage instance report 30 without departing from the scope of the invention. For example, analysis portion 34 may include additional storage options 36 that were evaluated by evaluator 26 and may also include the cumulative score 38 for each of the additional storage options 36. As another example, the weight 22 section may be omitted from the storage instance report 30. As yet another example, the cumulative score 38 section may be omitted.

FIG. 3 is a diagram of an embodiment of a storage option report 40 that may be generated by system 10 of FIG. 1. Report generator 28 may generate storage option report 40 to describe the storage options that evaluator 26 evaluated for the storage instance. According to the illustrated embodiment, storage option report 40 includes a storage instance section 42 and a storage option section 45. Storage instance section 42 may include information corresponding to the storage instances that may be analyzed. For example, storage option report 40 may include a section 42a for an OLTP system, a section 42b for an e-mail system and a section 42c for a home directory system.

Storage option report 40 may display a storage option portion 45 that describes the evaluation of the storage options for the storage instances. According to the illustrated embodiment, storage option portion 44 includes an Enterprise Storage Area Network (ESAN) section 44a, a Departmental Storage Area Network (DSAN) section 44b, and Enterprise Network Attached Storage (ENAS) section 44c, a Departmental Network Attached Storage (DNAS) section 44d, and a Direct Attached Storage (DAS) section 44e. Each storage option section 44a through 44e may display the cumulative scores determined by evaluator 26 for each storage option as was described with reference to FIG. 1. For example, storage option portion 44 reports the two highest cumulative scores for the OLTP system as scores for the ESAN option 44a and DSAN option 44b, with the score for the ESAN option ranking higher than the score for the DSAN option. Storage option report 40 may be used to compare the different storage options that may be selected for different storage instances. For example, the evaluation for a home directory storage instance 42c may be compared with the evaluation of the OLTP system to illustrate how different storage solutions may be selected for different storage instances.

Using the storage option storage report 40, a storage instance may be upgraded, modified, or designed using the storage option that meets the requirements of the data characteristics represented by workload descriptor 20. It will be understood, however, that storage option report 40 may be used for any other suitable purpose without departing from the scope of the invention. For example, storage option report 40 may be used to evaluate a current storage option and how it fits a storage instance compared with other available options in the market. Although a storage option with the highest cumulative score is generally described as being the optimal fit for the storage instance, any other storage option close in range to the highest scoring storage option may be selected. For example, for home directories 42c, storage options 44c and 44d are close in range so that if a DNAS storage option 44d is not selected, ENAS storage option 44c may be the next most suitable storage option.

Modifications, additions, or omissions may be made to storage option report 40 without departing from the scope of the invention. For example, storage option report 40 may display one storage instance 42 at a time. As another example, workload descriptors 20 for each storage instance 42 may be included. Although the storage options described in storage option report 40 are current storage options deployed by EDS, any other suitable any number of storage option sections representing other suitable storage options may be included in storage option report 40 without departing from the scope of the invention.

FIG. 4 is a flowchart illustrating one embodiment of a method for evaluating storage options in accordance with the present invention. The method begins at step 50, where processor 14 identifies workload descriptors 20 corresponding to a storage instance. For example, processor 14 may access workload descriptor module 20 from memory 16 to identify the workload descriptors 20 that are used to describe the storage instance.

At step 52, processor 14 associates a weight 22 and a workload value 24 with a workload descriptor 20 of the identified workload descriptors 20. Weight 22 and workload value 24 may be selected for workload descriptor 20 as was more particularly described with reference to FIG. 1. Evaluator 26 evaluates storage options using the weight 22 and workload value 24 for the workload descriptor at step 54. According to the one embodiment, evaluator 26 generates a raw score for each storage option using the weight 22 and workload value 24. Processor 14 may act as evaluator 26 to execute the evaluation of storage options using any suitable computation procedure.

The method proceeds to step 56 to determine if there is a next workload descriptor 20 to process. If there is a next workload descriptor 20 to process, the method returns to step 52, where processor 14 associates a weight 22 and a workload value 24 with the next workload descriptor 20. If there is no next workload descriptor 20 to be processed at step 56, the method proceeds to step 58 where processor 14 analyzes the storage options for the storage instance based on the evaluations. For example, processor 14 may compute a cumulative score for each storage option using the raw scores that were evaluated at step 54.

The analysis for the storage instance is displayed at step 60. According to the illustrated embodiment, the analysis may be displayed at input/output module 12, using any format generated by report generator 28. For example, a storage instance report 20 may be used to display the analysis for the storage instance. As another example, storage option report 40 may be used to display the analysis for the storage instance. After displaying the analysis for the storage instance at step 60, the method terminates.

Steps may be added, omitted, modified, or performed in any suitable order without departing from the scope of the invention. For example, identifying workload descriptors corresponding to a storage instance at step 50 may be replaced with a step of identifying a workload profile for the storage instance, where the workload profile includes parameters that are common to the storage instance. As another example, evaluating storage options for the workload descriptor based on weight 22 and workload value 24 at step 54 may be performed substantially simultaneously with analyzing the storage options for the storage instance based on the evaluations at step 58. As yet another example, a step may be added where each storage option being evaluated is assigned a rating corresponding to how the storage option meets the value 24 of each workload descriptor 20. For example, a rating of “very good” may be used to represent that an ESAN option may obtain a high raw score if a workload descriptor 20 is associated with a value of “high.” DSAN, ENAS, and DAS options may obtain a rating of “good” for the same workload descriptor 20 while a DNAS option may receive a rating of “poor” for the workload descriptor 20. Using those ratings, the analysis of the storage options may be performed using both the raw scores and the ratings.

Certain embodiments of the invention may provide one or more technical advantages. A technical advantage of one embodiment may be that a more suitable storage solution may be selected by considering the impact of data characteristics in the evaluation of storage options. Another technical advantage of an embodiment may be that a more cost effective storage solution may be selected by considering aspects of data characteristics that affect contractual, physical, and technical aspects of implementing the storage solution. Yet another technical advantage of an embodiment may be that storage management may be more vendor independent by focusing on the data services required and not on the applications or the environment of the system.

Although an embodiment of the invention and its advantages are described in detail, a person skilled in the art could make various alterations, additions, and omissions without departing from the spirit and scope of the present invention as defined by the appended claims.

What is claimed is:

1. A method for evaluating a storage option, comprising:
identifying a plurality of workload descriptors associated with a storage instance, each workload descriptor corresponding to a data characteristic, the storage instance having one or more storage attributes;
repeating the following for each workload descriptor of the plurality of workload descriptors:
selecting a workload descriptor;
associating a weight and a workload parameter value with the selected workload descriptor, the weight representing an impact of the workload parameter value on a storage attribute of the storage instance; and
evaluating one or more storage options in accordance with the weight and the workload parameter value; and
determining a storage option from the one or more storage options for the storage instance according to the evaluation of the one or more storage options.

2. The method of claim 1, further comprising reporting the plurality of workload descriptors and the evaluation of the one or more storage options.

3. The method of claim 1, wherein identifying the plurality of workload descriptors associated with the storage instance further comprises identifying the plurality of workload descriptors that affect at least one storage attribute of the storage instance.

4. The method of claim 1, further comprising grouping the plurality of workload descriptors corresponding to the storage instance into a workload profile, the workload profile describing a commonality of the data characteristics associated with the storage instance.

5. The method of claim 1, wherein evaluating one or more storage options in accordance with the weight and the workload parameter value further comprises calculating a raw score for each workload descriptor of the plurality of workload descriptors according to the workload parameter value and the weight associated with each workload descriptor of the plurality of workload descriptors.

6. The method of claim 5, wherein evaluating one or more storage options in accordance with the weight and the workload parameter value further comprises calculating a cumulative score for the one or more storage options according to the raw score for each workload descriptor of the plurality of workload descriptors.

7. A system for evaluating a storage option, comprising:
a memory operable to store:
a plurality of workload descriptor, each workload descriptor corresponding to a data characteristic,
one or more weights; and
a plurality of workload parameter values; and
a processor coupled to the memory and operable to:
identify the plurality of workload descriptors associated with a storage instance, the storage instance having one or more storage attributes;
repeat the following for each workload descriptor of the plurality of workload descriptors:
select a workload descriptor;
associate a weight of the one or more weights and a workload parameter value of the plurality of workload parameter values with the selected workload descriptor, the weight representing an impact of the workload parameter value on a storage attribute of the storage instance; and
evaluate one or more storage options in accordance with the weight and the workload parameter value; and
determine a storage option from the one or more storage options for the storage instance according to the evaluation of the one or more storage options.

8. The system of claim 7, the processor further operable to generate a report describing the plurality of workload descriptors and the evaluation of the one or more storage options.

9. The system of claim 7, the processor further operable to identify the plurality of workload descriptors that affect at least one storage attribute of the storage instance.

10. The system of claim 7, the processor further operable to group the plurality of workload descriptors corresponding to the storage instance into a workload profile, the workload profile describing a commonality of the data characteristics associated with the storage instance.

11. The system of claim 7, the processor further operable to evaluate the one or more storage options by calculating a raw score for each workload descriptor of the plurality of workload descriptors according to the workload parameter value and the weight associated with each workload descriptor of the plurality of workload descriptors.

12. The system of claim 11, the processor further operable to evaluate the one or more storage options by calculating a cumulative score for the one or more storage options according to the raw score for each workload descriptor of the plurality of workload descriptors.

13. Software for evaluating a storage option, the software embodied in a computer-readable medium and operable to:
identify a plurality of workload descriptors associated with a storage instance, each workload descriptor corresponding to a data characteristic, the storage instance having one or more storage attributes;
repeat the following for each workload descriptor of the plurality of workload descriptors:
select a workload descriptor;
associate a weight and a workload parameter value with the selected workload descriptor, the weight representing an impact of the workload parameter value on a storage attribute of the storage instance; and
evaluate one or more storage options in accordance with the weight and the workload parameter value; and
determine a storage option from the one or more storage options for the storage instance according to the evaluation of the one or more storage options.

14. The software of claim 13, further operable to report the plurality of workload descriptors and the evaluation of the one or more storage options.

15. The software of claim 13, further operable to identify the plurality of workload descriptors that affect at least one storage attribute of the storage instance.

16. The software of claim 13, further operable to group the plurality of workload descriptors corresponding to the storage instance into a workload profile, the workload profile describing a commonality of the data characteristics associated with the storage instance.

17. The software of claim 13, further operable to calculate a raw score for each workload descriptor of the plurality of workload descriptors according to the workload parameter value and the weight associated with each workload descriptor of the plurality of workload descriptors.

18. The software of claim 17, further operable to calculate a cumulative score for the one or more storage options according to the raw score for each workload descriptor of the plurality of workload descriptors.

19. A system for evaluating a storage option, comprising:
means for identifying a plurality of workload descriptors associated with a storage instance, each workload descriptor corresponding to a data characteristic, the storage instance having one or more storage attributes;
means for repeating the following for each workload descriptor of the plurality of workload descriptors:
selecting a workload descriptor;
associating a weight and a workload parameter value with the selected workload descriptor, the weight representing an impact of the workload parameter value on a storage attribute of the storage instance; and
evaluating one or more storage options in accordance with the weight and the workload parameter value; and
means for determining a storage option from the one or more storage options for the storage instance according to the evaluation of the one or more storage options.

20. A method for evaluating storage options comprising:
identifying a plurality of workload descriptors associated with a storage instance, the storage instance having one or more storage attributes, each workload descriptor corresponding to a data characteristic and affecting at least one storage attribute of the storage instance;
grouping the plurality of workload descriptors corresponding to the storage instance into a workload profile, the workload profile describing a commonality of the data characteristics associated with the storage instance;
repeating the following for each workload descriptor of the plurality of workload descriptors:
selecting a workload descriptor;
associating a weight and a workload parameter value with the selected workload descriptor, the weight representing an impact of the workload parameter value on a storage attribute of the storage instance; and
evaluating one or more storage options in accordance with the weight and the workload parameter value by:
calculating a raw score for each workload descriptor of the plurality of workload descriptors according to the workload parameter value and the weight associated with each workload descriptor of the plurality of workload descriptors; and
calculating a cumulative score for the one or more storage options according to the raw score for each workload descriptor of the plurality of workload descriptors;
determining a storage option from the one or more storage options for the storage instance according to the evaluation of the one or more storage options; and
reporting the plurality of workload descriptors and the evaluation of the one or more storage options.
